(19) United States
(12) Patent Application Publication
(10) Pub. No.: US 2024/0367581 A1
(43) Pub. Date: Nov. 7, 2024

(54) VEHICULAR ILLUMINATION MODULE AND METHOD OF MANUFACTURING

(71) Applicant: Magna Mirrors of America, Inc., Holland, MI (US)

(72) Inventor: Justin E. Sobecki, Rockford, MI (US)

(21) Appl. No.: 18/650,575

(22) Filed: Apr. 30, 2024

Related U.S. Application Data
(60) Provisional application No. 63/499,751, filed on May 3, 2023.

(51) Int. Cl. B60Q 1/26

(52) U.S. Cl. CPC B60Q 1/2665; B60Q 1/2696; B60Q 2400/50

(57) ABSTRACT

A method of manufacturing a vehicular illumination module includes disposing an illumination source at a housing and forming a mask by applying a layer of spectrally-selective light absorbing material at a substrate. A photoresistant layer is applied onto the light absorbing material. A template is positioned at the photoresistant layer and includes a transmissive portion that allows UV light to pass through and a non-transmissive portion that blocks UV light. Exposing the mask to UV light removes a first portion of the photoresistant layer aligned with the transmissive portion to dissipate. A first portion of the light absorbing material is not covered. A second portion of the light absorbing material is covered by a second portion of the photoresistant layer. The first portion of the light absorbing material and the second portion of the photoresistant layer are removed. The second portion of the light absorbing material remains at the substrate.

### CROSS REFERENCE TO RELATED APPLICATION

The present application claims the filing benefits of U.S. provisional application Ser. No. 63/499,751, filed May 3, 2023, which is hereby incorporated herein by reference in its entirety.

### FIELD OF THE INVENTION

The present invention relates to illumination modules for vehicles and, more particularly, to an illumination module that projects an icon or image onto the ground at or near the vehicle.

### BACKGROUND OF THE INVENTION

It is known to provide illumination or light sources at the side of the vehicle, such as to provide security lighting or convenience lighting at the side of the vehicle. For example, such lighting devices are described in U.S. Pat. Nos. 6,349,450; 6,550,103; 5,371,659; 5,669,699; 5,823,654 and 5,497,305, which are hereby incorporated herein by reference in their entireties. Typically, such lighting devices provide illumination along the side of the vehicle and down to the ground at the side of the vehicle.

### SUMMARY OF THE INVENTION

The present invention provides an illumination module or device for a vehicle, such as for mounting at an exterior mirror assembly, for providing illumination at the side or door of the vehicle and for projecting an icon or logo onto the ground area at the side of the vehicle.

For example, a vehicular illumination module includes a housing mounted to an exterior component of a vehicle equipped with the vehicular illumination module. The exterior component (such as an exterior rearview mirror assembly or door handle assembly) is configured to mount at a side of the vehicle. A light source and a mask are accommodated by the housing. With the exterior component of the vehicle mounted at the side of the vehicle and when the light source is electrically powered to emit light, light emitted by the light source passes through the mask and projects an icon onto a ground region adjacent to and along the side of the vehicle at which the exterior component is mounted. The mask includes a pattern of ink or spectrally-selective light absorbing material disposed along a glass surface of the mask, The pattern of ink at least partially tints the glass surface of the mask so that, when light emitted by the light source passes through the mask and the icon is projected onto the ground region, the projected icon is at least partially tinted and the pattern of ink corresponds to the projected icon. The pattern of ink of the mask includes (i) a first ink layer that corresponds to a first portion of the projected icon and (ii) a second ink layer that corresponds to a second portion of the projected icon.

A method of manufacturing the vehicular illumination module may include providing a housing, disposing an illumination source at the housing, and forming a mask. Forming the mask includes providing a glass lens and applying a first ink layer over and along a surface of the glass lens. With the first ink layer along the surface of the glass lens, the method includes applying a photoresistant layer over and along the first ink layer. With the photoresistant layer over and along the first ink layer, the method includes positioning a mask template over the photoresistant layer. The mask template includes (i) a transmissive portion that at least partially allows UV light to pass through the mask template at the transmissive portion and (ii) a non-transmissive portion that at least partially blocks UV light from passing through the mask template at the non-transmissive portion. With the mask template positioned over the photoresistant layer, the method includes exposing the mask to UV light. Exposing the mask to UV light causes a first portion of the photoresistant layer aligned with the transmissive portion of the mask template and exposed to the UV light to dissipate from the first ink layer. With the first portion of the photoresistant layer dissipated from the first ink layer, a second portion of the photoresistant layer aligned with the non-transmissive portion of the mask template and not exposed to the UV light remains at the first ink layer. After exposing the mask to UV light, a first portion of the first ink layer is exposed through the photoresistant layer and a second portion of the first ink layer is covered by the second portion of the photoresistant layer. The method includes removing the first portion of the first ink layer from the surface of the glass lens and the mask and removing the second portion of the photoresistant layer from the first ink layer and the mask. The second portion of the first ink layer remains along the surface of the glass lens and at least partially tints the surface of the glass lens so that, when a vehicular illumination module is equipped with the mask, and when light emitted by a light source of the vehicular illumination module passes through the mask, the vehicular illumination module projects an icon onto a ground surface adjacent to and along a side of the vehicle at which the vehicular illumination module is mounted. The projected icon is at least partially tinted and the second portion of the first ink layer corresponds to at least a portion of the projected icon.

These and other objects, advantages, purposes and features of the present invention will become apparent upon review of the following specification in conjunction with the drawings.

### BRIEF DESCRIPTION OF THE DRAWINGS

FIG. 1 is a side view of a vehicle with an illumination and projection light module at the exterior rearview mirror of the vehicle;

FIG. 2 is a perspective view of the vehicle of FIG. 1, with the projection light module electrically operated to emit light to illuminate an icon at the ground along the side of the vehicle;

FIG. 3 is a perspective view of the projection light module; and

FIGS. 4A and 4B depict an example method of manufacturing a mask for the projection light module, where the mask includes a multi-layer pattern that defines the icon projected onto the ground by the projection light module.

### DESCRIPTION OF THE PREFERRED EMBODIMENTS

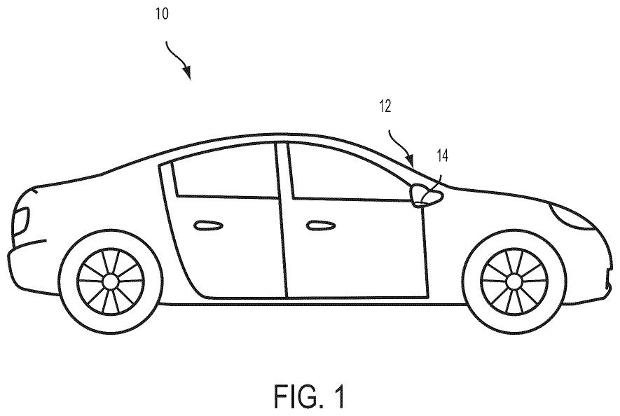

Referring now to the drawings and the illustrative embodiments depicted therein, an illumination module 14 may be disposed at a side and exterior portion of a vehicle 10, such as a vehicle exterior rearview mirror assembly 12 or the like, and electrically operable to emit light, where the illumination module 14 provides projection or backlighting of an image or icon or logo or indicia and/or ground illumination (FIG. 1). The illumination module 14 includes a housing or casing that is configured to be received (and optionally snapped or otherwise secured) at or in an opening of the mirror assembly (or elsewhere at the vehicle, such as at a door handle assembly or underbody of the vehicle such as below a driver or passenger side door or the like), with an outer portion or cover being at or generally flush with the outer surface of the mirror assembly or door handle or vehicle body portion at which the illumination module is mounted. The illumination module may utilize aspects of the illumination modules described in U.S. Pat. Nos. 11,235,699; 10,744,930; 10,576,896; 9,487,142; 8,764,256 and/or 8,801,245, which are hereby incorporated herein by reference in their entireties.

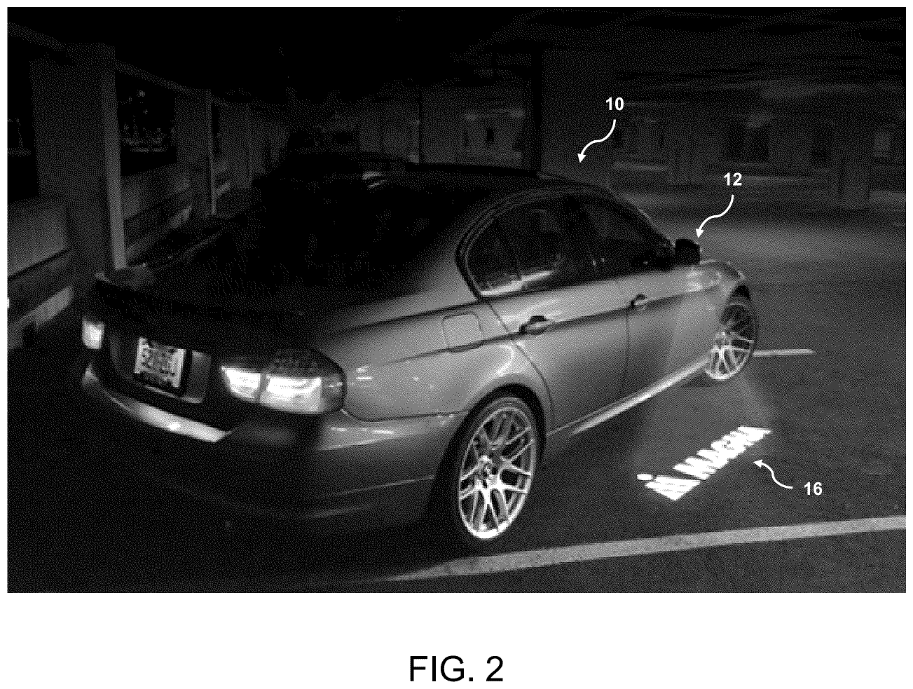

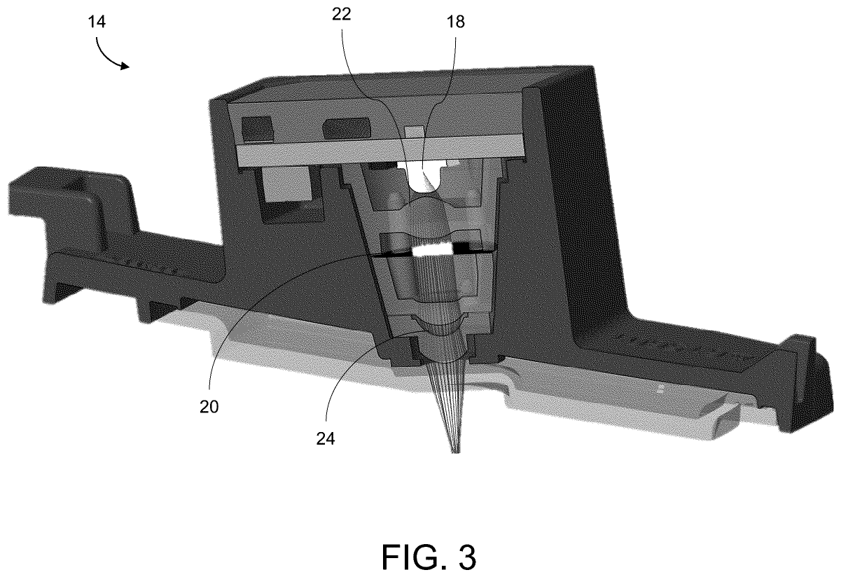

As shown in FIGS. 2 and 3, when the illumination module 14 is electrically operated, the illumination module emits light that projects an icon or logo or image 16 onto a surface or region at or near the vehicle 10, such as the ground surface or ground region at or near or along the side of the vehicle 10. The projected image 16 may provide ground illumination at or along the side of the vehicle. The illumination module 14 includes one or more electrically operable light sources 18, such as one or more light emitting diodes (LEDs) or microLEDs, that are electrically operable to emit light through one or more masks or glass layers 20 within the module 14. The illumination module 14 may also include a condensing optic 22 and one or more projection lenses 24 that focus and magnify light as it passes from the light source 18, through the one or more masks 20 and out of the illumination module 14. In the illustrated example, light emitted by the light source 18 passes through the condensing optic 22, then the one or more masks 20, and then the one or more projection lenses 24 before being emitted from the illumination module 14 and exterior of the vehicle 10. The one or more masks 20 block or attenuate specific spectral ranges of light emitted by the LED and passing through the condensing optic 22 so that the projection lenses 18 can magnify and project the light onto an object (e.g., the ground), with the light in the form of a desired image or logo due to the image or pattern formed on the mask 20. In other words, the mask 20 includes the image or pattern to establish or define the icon that is projected by the illumination module 14.

As discussed further below, the mask 20 may have one or more opaque and/or colored semi-transparent inks or spectrally-selective light absorbing materials disposed along a surface of the mask 20 to define the pattern or image or logo that is then projected onto the ground. The one or more ink layers may be coated and then etched onto the surface of the mask 20. The illumination module 14 may include one mask 20 with multiple different opaque and/or colored layers of ink or spectrally-selective light absorbing materials so that the entire pattern or image for the projected icon is formed on a single mask 20. Thus, the illumination module 14 does not require multiple masks with complicated focusing and spacing within the illumination module to achieve multi-colored, clear, and detailed image projection.

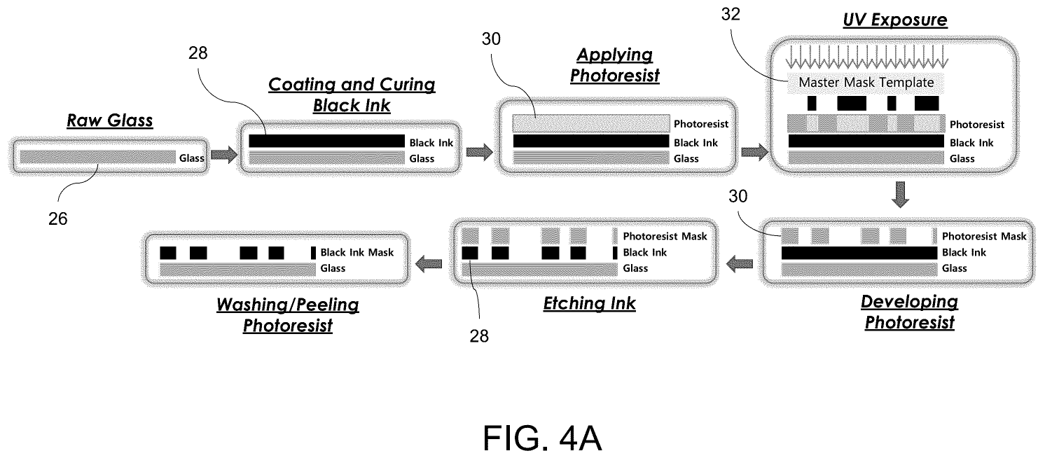

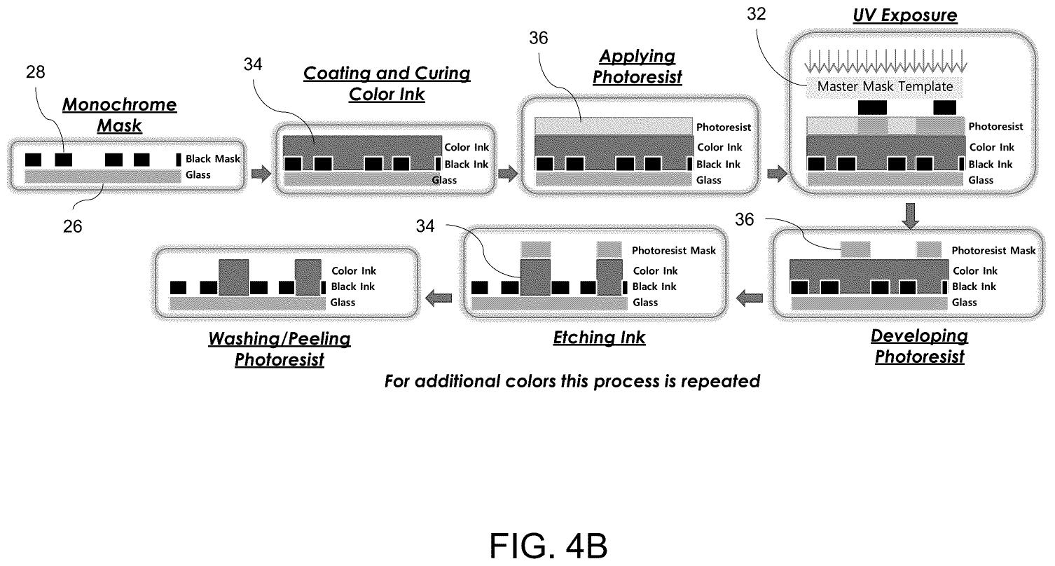

FIGS. 4A and 4B illustrate an example method of forming the mask 20 with a multi-colored pattern formed thereat for projecting a corresponding multi-colored icon from the illumination module 14. As shown in FIGS. 4A and 4B, the mask 20 includes a glass plate or base layer 26 and a first ink layer 28 is applied onto a top or first surface of the glass plate 26. After the first surface of the glass plate 26 is coated with the first ink layer 28 and the first ink layer 28 is cured, a layer of photoresistant material or a first photoresistant layer 30 is applied over the first ink layer 28 (i.e., at an opposite side of the ink layer from the glass plate).

With the first ink layer 28 and the first photoresistant layer 30 applied to the glass plate 26, at least a portion of a master mask template 32 is positioned over the first photoresistant layer 30 (i.e., at an opposite side of the photoresistant material from the first ink layer). The portion of the master mask template 32 positioned over the first photoresistant layer 30 may correspond to the layer of ink being applied to the glass substrate 26. UV light is then emitted toward an upper side of the mask template 32 (i.e., an opposite side of the mask template from the photoresistant material) and the light passes through transmissive portions of the mask template 32 and toward the glass plate 26. That is, the mask template 32 includes transmissive portions that at least partially allow UV light to pass through the mask template 32 to the first photoresistant layer 30 and the mask template 32 includes non-transmissive portions that at least partially block UV light from passing through the mask template 32 to the first photoresistant layer 30. The first photoresistant layer 30 reacts to being exposed to the UV light and is substantially or completely removed or dissipated at areas corresponding to the transmissive portions of the mask template 32. Thus, portions of the first photoresistant layer 30 that are aligned with non-transmissive portions of the mask template 32 remain at the mask 20 after the mask 20 is exposed to the UV light.

After the UV exposure, the first photoresistant layer 30 is developed and at least a portion of the first ink layer 28 is exposed through the first photoresistant layer 30. The exposed portion of the first ink layer 28 may substantially correspond to the transmissive portions of the mask template 32 as the first photoresistant layer 30 was removed at the portions that aligned with the transmissive portions of the mask template 32 during UV exposure. The portions of the first ink layer 28 that are exposed through the first photoresistant layer 30 are then etched away, leaving only the portions of the first photoresistant layer 30 that aligned with non-transmissive portions of the mask template 32 and the portions of the first ink layer 28 aligned with these portions of the first photoresistant layer 30. Thus, after exposing the first photoresistant layer 30 to UV light through the mask template 32 to remove portions of the first photoresistant layer 30, the remaining portions of the first photoresistant layer 30 effectively act as a template for etching or removing portions of the first ink layer 28 from the glass plate 26.

After portions of the first ink layer 28 are etched, the remaining portions of the first photoresistant layer 30 are removed, such as by washing or peeling the first photoresistant layer from the mask 20. For masks 20 that project monochrome icons, the mask may be complete after removing the first photoresistant layer 30.

FIG. 4B illustrates additional steps that may be taken to apply one or more additional layers of ink to the mask 20, such as layers of differently colored ink or additional layers of the same color ink. After the first photoresistant layer 30 is removed from the first ink layer 28, a second ink layer 34 is applied at the first side of the glass plate 26, such as over and along the first side of the glass plate and over and along the first ink layer 28. A second layer of photoresistant material or a second photoresistant layer 36 is then applied over the second ink layer 34 and at least a portion of the master mask template 32 is aligned with the mask 20. The portion of the master mask template 32 disposed over the second photoresistant layer 36 may correspond to the second ink layer 34 being applied to the glass substrate 26.

As shown in FIG. 4B, when applying the second ink layer 34, the portion of the mask template 32 disposed over the second photoresistant layer 36 may have a different pattern of transmissive portions and non-transmissive portions as compared to the portion of the mask template 32 disposed over the first photoresistant layer 30 when the first ink layer 28 is applied. For example, the different portions of the master mask template 32 may include different layers or segments of the mask template 32 corresponding to different portions of the logo to be displayed by the illumination module. Thus, the second ink layer 34 may be applied according to the different pattern and may remain at the glass plate 26 in a different configuration than the first ink layer 28. With the mask template 32 aligned with the mask 20, the mask 20 is exposed to UV light and portions of the second photoresistant layer 36 that align with the transmissive portions of the template 32 are removed or dissipated.

With the remaining portion of the second photoresistant layer 36 (i.e., the portion that aligned with non-transmissive portions of the template) covering portions of the second ink layer 34 and leaving other portions of the second ink layer 34 exposed, the exposed portions of the second ink layer 34 are etched or otherwise removed from the mask 20 to leave portions of the second ink layer 34 covered by the second photoresistant layer 36 and the remaining portions of the first ink layer 28 at the mask 20. Thus, when the second photoresistant layer 36 is removed from the mask 20, the first ink layer 28 and the second ink layer 34 remain at the first side of the glass plate 26 to define the pattern for projecting the icon through the mask 20. This process may be repeated as many times as necessary to add different colored ink layers to the mask and/or additional layers of the same color ink to the mask.

As shown, the first ink layer 28 and the second ink layer 34 may be substantially adjacent one another, with minimal or zero spacing between the patterns formed by each respective layer. For example, the mask can be configured to provide images with any suitable fine lines and details, such as an image with a minimum line width of 20 micrometers or less and a logo interval of at least 50 micrometers. Moreover, the respective ink layers may include any suitable color such as black, red, yellow, blue and the like. Semi-transparent or translucent black layers and/or at least partially opaque white layers may be used as well.

Thus, the mask 20 provides a template or pattern and the illumination module 14 emits light that passes through the mask 20 to project a multi-colored image or icon onto the ground at or near the side of the vehicle. The mask 20 may include one or more layers or portions of semi-transparent ink that define the pattern, with each layer disposed on the same side or surface of the mask. For example, the mask 20 may include two or more different layers, three or more different layers, four or more different layers, and the like. Each layer may comprise a different color. Therefore, the illumination module 14 requires only a single mask to provide a detailed and/or multi-colored or multi-layered icon on the ground surface.

The illumination module 14 may include one or more light sources that emit white light toward and that passes through the mask 20 for projecting the icon. Optionally, the light sources may emit any suitable color light, such as a visible color light and/or near infrared or infrared light. For example, the illumination module 14 may project an icon onto the ground using near infrared light so that a camera viewing the near infrared light may capture image data representative of the near infrared icon, such as for calibrating the camera or determining a surface profile of the ground surface based on distortion of the projected image or pattern on the ground surface.

For example, an illumination module includes a housing configured to be disposed at a vehicle equipped with the vehicular illumination module, a light source accommodated by the housing, and a mask. The light source is electrically operable to emit light. The mask includes (i) a substrate and (ii) a pattern of spectrally-selective light absorbing material disposed at a surface of the substrate. With the housing disposed at the exterior portion of the vehicle, and when the light source is electrically operated to emit light, the light source emits light that passes through the mask forms an icon projected by the vehicular illumination module. The pattern of spectrally-selective light absorbing material at least partially tints the surface of the mask so that, when light emitted by the light source passes through the mask, the projected icon is at least partially colored by the pattern of spectrally-selective light absorbing material. The pattern of spectrally-selective light absorbing material includes (i) a first spectrally-selective light absorbing material layer that at least partially colors a first portion of the projected icon and (ii) a second spectrally-selective light absorbing material layer that at least partially colors a second portion of the projected icon.

In some examples, the first spectrally-selective light absorbing material layer and the second spectrally-selective light absorbing material layer do not overlap on the surface of the substrate. In some implementations, the first spectrally-selective light absorbing material layer at least partially colors the first portion of the projected icon a first color, and the second spectrally-selective light absorbing material layer at least partially colors the second portion of the projected icon a second color, where the second color is different from the first color.

Optionally, with the housing disposed at the vehicle, the vehicular illumination module is mounted at an exterior component of the vehicle. With the vehicular illumination module mounted at the exterior component mounted of the vehicle, and when the light source is electrically operated to emit light, the light source emits light to project the icon onto a ground region along a side adjacent of the vehicle. Further, the exterior component may include an exterior rearview mirror assembly of the vehicle or a door handle assembly of the vehicle.

Optionally, with the housing disposed at the vehicle, the vehicular illumination module is mounted at an interior component of the vehicle. With the vehicular illumination module mounted at the interior component mounted of the vehicle, and when the light source is electrically operated to emit light, the light source emits light to project the icon onto an interior surface of an interior cabin of the vehicle. Further, the interior component may include an interior rearview mirror assembly of the vehicle or an overhead console module of the vehicle. The projected icon may include a logo. The substrate may include a glass substrate.

The illumination source may comprise any suitable illumination source, such as one or more light emitting diodes (LEDs), such as white light-emitting LEDs or high intensity power LEDs (such as the types described in U.S. Pat. Nos. 7,195,381 and/or 6,690,268, which are hereby incorporated herein by reference in their entireties) or organic light emitting diodes (OLEDs) or electroluminescent light sources or the like. The illumination source may comprise a substantially white light-emitting illumination source, or may comprise a colored light-emitting illumination source (or a white light-emitting illumination source may emit light that passes through a color filter or the like) to provide color illumination (such as blue or other color as desired) at the vehicle side area depending on the particular application of the illumination module. For example, the illumination module may emit colored light that may match or correspond to the interior and/or exterior lighting of the particular vehicle to which the illumination module is mounted.

The icon or indicia or logo or emblem may comprise the vehicle manufacturer logo or the like, or may comprise a selected icon or indicia or logo, such as may be selected by the owner of the vehicle. For example, the owner of the vehicle may select a module having a desired icon or indicia or logo element or optical properties and the selected illumination module may be installed in the vehicle door handle and/or mirror assembly (or elsewhere on the vehicle, such as at or on or in the vehicle door or at or on or in a side panel of the vehicle or the like) to provide the customized or personalized ground illumination function. Such a selection and installation of the illumination module may be performed during manufacturing of the vehicle or as an aftermarket change to the vehicle. The icon illumination module thus may provide a personalized or customized illumination at the side of the vehicle, such as by utilizing aspects of the systems and assemblies described in U.S. Pat. Nos. 7,626,749; 7,255,451 and/or 7,289,037, which are hereby incorporated herein by reference in their entireties. Optionally, the illumination module may be disposed at an exterior rearview mirror assembly of the vehicle (such as at the housing of the mirror assembly or in the housing and behind the reflective element so as to be viewable through the reflective element) or the like, or may be disposed elsewhere at the exterior of the vehicle, such as at a door handle of the vehicle or the like. Optionally, the illumination module may be disposed at a lower region of the vehicle, such as at a lower region of a vehicle door, whereby the illumination module is activated to project the icon onto a ground region when the door is opened. Optionally, an illumination module with a backlit icon of the types described above may be disposed at an interior portion of a vehicle, such as at an interior rearview mirror assembly (such as at a mirror casing or behind a reflective element and viewable through the reflective element or the like) of the vehicle or such as at or proximate to the interior door lock button or switch or the like. For example, the illumination module may be mounted at the interior rearview mirror assembly, an overhead console module or at the headliner of the vehicle and operate to project the icon onto an interior region or surface of the vehicle (such as the dashboard, center console, floor, and the like). The illumination module thus may provide a security indicator function at the interior rearview mirror assembly or elsewhere in the interior cabin of the vehicle.

Optionally, the cover and/or housing may be overmolded over the illumination source or sources and circuitry to provide a substantially sealed and substantially water impervious illumination module. For example, the housing may be overmolded over and around a metal stamping or stamped circuit element or plate with the illumination source or sources (such as LEDs or the like) fastened thereto or otherwise established thereon, or the housing may be overmolded over and around a printed circuit board or element with the illumination sources established thereon.

Thus, the present invention provides an illumination module at an exterior portion of the vehicle. Optionally, the illumination device or module of the present invention may be operable as an indicator to provide the driver with feedback as the driver or user or operator uses his or her key fob or as the passive or keyless entry system (PKE system) of the vehicle operates. Optionally, the illumination device or module may display vehicle logos or the like, and may use variable color LEDs that could be linked to an interior lighting system of the vehicle, such as to a MYCOLOR™ interior lighting system of the vehicle or the like.

Although shown and described as being disposed at an exterior rearview mirror assembly and/or door handle and/or exterior portion of a vehicle for providing illumination at a side of a vehicle, it is envisioned that the light module of the present invention is suitable for other applications. For example, a light module of the present invention may be disposed at an interior portion of a vehicle, such as at an interior rearview mirror assembly (such as at a mirror casing or behind a reflective element and viewable through the reflective element or the like) of the vehicle or the like, whereby actuation of the light module may provide broad illumination of the dashboard and/or instrument panel of the vehicle (generally beneath the mirror assembly), and may project a beam of light to illuminate (such as at a greater intensity of light as compared to the broad illumination) a targeted portion of the interior of the vehicle (such as for map reading or the like). Also, for example, a light module of the present invention may be suitable for use in non-automotive lighting applications, such as residential lighting or commercial lighting or the like. For example, a light module of the present invention may be converted to replace a household or residential or commercial business or office building light bulb, whereby the light module may provide normal lighting (that broadly illuminates the area surrounding the light module) in addition to projection lighting, such as in a similar manner as described above.

Changes and modifications in the specifically described embodiments may be carried out without departing from the principles of the present invention, which is intended to be limited only by the scope of the appended claims as interpreted according to the principles of patent law.

1. A method of manufacturing a vehicular illumination module, the method comprising:
providing a housing;
disposing an illumination source at the housing;
forming a mask, wherein forming the mask comprises:
(a) providing a substrate, the substrate having a first side and a second side separated from the first side by a thickness dimension of the substrate;
(b) applying a layer of spectrally-selective light absorbing material at the first side of the substrate;
(c) with the layer of spectrally-selective light absorbing material applied at the first side of the substrate, applying a photoresistant layer onto the layer of spectrally-selective light absorbing material;
(d) with the photoresistant layer applied onto the layer of spectrally-selective light absorbing material, positioning a mask template at the photoresistant layer, wherein the mask template comprises (i) a transmissive portion that at least partially allows UV light to pass through the mask template at the transmissive portion and (ii) a non-transmissive portion that at least partially blocks UV light from passing through the mask template at the non-transmissive portion;
(e) with the mask template positioned at the photoresistant layer, exposing the mask to UV light, wherein exposing the mask to UV light removes a first portion of the photoresistant layer aligned with the transmissive portion of the mask template and at least partially exposed to the UV light from the layer of spectrally-selective light absorbing material, and wherein, with the first portion of the photoresistant layer removed from the layer of spectrally-selective light absorbing material, a second portion of the photoresistant layer aligned with the non-transmissive portion of the mask template and at least partially blocked from exposure to the UV light remains at the layer of spectrally-selective light absorbing material;
(f) wherein, after exposing the mask to UV light, a first portion of the layer of spectrally-selective light absorbing material is not covered by the photoresistant layer and a second portion of the layer of spectrally-selective light absorbing material is covered by the second portion of the photoresistant layer;
(g) removing the first portion of the layer of spectrally-selective light absorbing material from the first side of the substrate;
(h) removing the second portion of the photoresistant layer from the second portion of the layer of spectrally-selective light absorbing material; and
(i) wherein, with the first portion of the layer of spectrally-selective light absorbing material removed from the first side of the substrate and the second portion of the photoresistant layer removed from the second portion of the layer of spectrally-selective light absorbing material, the second portion of the layer of spectrally-selective light absorbing material remains at the first side of the substrate;
disposing the mask at the housing of the vehicular illumination module; and
wherein, with the mask disposed at the housing of the vehicular illumination module, and when the illumination source of the vehicular illumination module is electrically operated to emit light, light emitted by the illumination source that passes through the mask forms an icon projected by the vehicular illumination module, and wherein the projected icon is at least partially colored by the second portion of the layer of spectrally-selective light absorbing material.

2. The method of claim 1, further comprising applying a second layer of spectrally-selective light absorbing material at the first side of the substrate, wherein the projected icon is at least partially colored by the second layer of spectrally-selective light absorbing material.

3. The method of claim 2, wherein forming the mask further comprises:
applying a second photoresistant layer onto the second layer of spectrally-selective light absorbing material and positioning a second mask template at the second photoresistant layer, wherein the second mask template comprises (i) a transmissive portion that at least partially allows UV light to pass through the mask template at the transmissive portion and (ii) a non-transmissive portion that at least partially blocks UV light from passing through the mask template at the non-transmissive portion; and
with the second mask template positioned at the second photoresistant layer, exposing the mask to UV light removes a first portion of the second photoresistant layer aligned with the transmissive portion of the second mask template and at least partially exposed to the UV light from the second layer of spectrally-selective light absorbing material, and wherein, with the second portion of the photoresistant layer removed from the second layer of spectrally-selective light absorbing material, a second portion of the second photoresistant layer aligned with the non-transmissive portion of the second mask template and at least partially blocked from exposure to the UV light remains at the second layer of spectrally-selective light absorbing material.

4. The method of claim 3, wherein forming the mask further comprises removing the first portion of the second layer of spectrally-selective light absorbing material from the first side of the substrate, and removing the second portion of the second photoresistant layer from the second portion of the second layer of spectrally-selective light absorbing material.

5. The method of claim 4, wherein the layer of spectrally-selective light absorbing material at least partially colors a first portion of the projected icon and the second layer of spectrally-selective light absorbing material at least partially colors a second portion of the projected icon.

6. The method of claim 4, wherein the layer of spectrally-selective light absorbing material and the second layer of spectrally-selective light absorbing material do not overlap at the first side of the substrate.

7. The method of claim 4, wherein the layer of spectrally-selective light absorbing material at least partially colors the projected icon a first color, and wherein the second layer of spectrally-selective light absorbing material at least partially colors the projected icon a second color, and wherein the second color is different from the first color.

8. The method of claim 1, wherein the illumination source comprises a light emitting diode (LED).

9. The method of claim 1, wherein the vehicular illumination module is configured to be disposed at an exterior rearview mirror assembly of a vehicle, and wherein, with the vehicular illumination module disposed at the exterior rearview mirror assembly of the vehicle, and when the illumination source is electrically operated to emit light, the vehicular illumination module projects the icon at a ground region at a side of the vehicle.

10. The method of claim 1, wherein the vehicular illumination module is configured to be disposed at a door handle assembly of a vehicle, and wherein, with the vehicular illumination module disposed at the door handle assembly of the vehicle, and when the illumination source is electrically operated to emit light, the vehicular illumination module projects the icon at a ground region at a side of the vehicle.

11. The method of claim 1, wherein the vehicular illumination module is configured to be disposed at an interior rearview mirror assembly of a vehicle, and wherein, with the vehicular illumination module disposed at the interior rearview mirror assembly of the vehicle, and when the illumination source is electrically operated to emit light, the vehicular illumination module projects the icon at an interior surface of an interior cabin of the vehicle.

12. The method of claim 1, wherein the vehicular illumination module is configured to be disposed at an overhead console of a vehicle, and wherein, with the vehicular illumination module disposed at the overhead console of the vehicle, and when the illumination source is electrically operated to emit light, the vehicular illumination module projects the icon at an interior surface of an interior cabin of the vehicle.

13. The method of claim 1, wherein the projected icon comprises a logo.

14. The method of claim 1, wherein the substrate comprises a glass substrate.

15. A method of manufacturing a vehicular illumination module, the method comprising:
providing a housing;
disposing an illumination source at the housing, wherein the illumination source comprises a light emitting diode (LED);
forming a mask, wherein forming the mask comprises:
(a) providing a glass substrate, the glass substrate having a first side and a second side separated from the first side by a thickness dimension of the glass substrate;
(b) applying a layer of spectrally-selective light absorbing material at the first side of the glass substrate;
(c) with the layer of spectrally-selective light absorbing material applied at the first side of the glass substrate, applying a photoresistant layer onto the layer of spectrally-selective light absorbing material;
(d) with the photoresistant layer applied onto the layer of spectrally-selective light absorbing material, positioning a mask template at the photoresistant layer, wherein the mask template comprises (i) a transmissive portion that at least partially allows UV light to pass through the mask template at the transmissive portion and (ii) a non-transmissive portion that at least partially blocks UV light from passing through the mask template at the non-transmissive portion;
(e) with the mask template positioned at the photoresistant layer, exposing the mask to UV light, wherein exposing the mask to UV light removes a first portion of the photoresistant layer aligned with the transmissive portion of the mask template and at least partially exposed to the UV light from the layer of spectrally-selective light absorbing material, and wherein, with the first portion of the photoresistant layer removed from the layer of spectrally-selective light absorbing material, a second portion of the photoresistant layer aligned with the non-transmissive portion of the mask template and at least partially blocked from exposure to the UV light remains at the layer of spectrally-selective light absorbing material;
(f) wherein, after exposing the mask to UV light, a first portion of the layer of spectrally-selective light absorbing material is not covered by the photoresistant layer and a second portion of the layer of spectrally-selective light absorbing material is covered by the second portion of the photoresistant layer;
(g) removing the first portion of the layer of spectrally-selective light absorbing material from the first side of the glass substrate;
(h) removing the second portion of the photoresistant layer from the second portion of the layer of spectrally-selective light absorbing material; and
(i) wherein, with the first portion of the layer of spectrally-selective light absorbing material removed from the first side of the glass substrate and the second portion of the photoresistant layer removed from the second portion of the layer of spectrally-selective light absorbing material, the second portion of the layer of spectrally-selective light absorbing material remains at the first side of the glass substrate;
disposing the mask at the housing of the vehicular illumination module;
wherein, with the mask disposed at the housing of the vehicular illumination module, and when the illumination source of the vehicular illumination module is electrically operated to emit light, light emitted by the illumination source that passes through the mask forms an icon projected by the vehicular illumination module, and wherein the projected icon is at least partially colored by the second portion of the layer of spectrally-selective light absorbing material; and
wherein the vehicular illumination module is configured to be disposed at an exterior portion of a vehicle, and wherein, with the vehicular illumination module disposed at the exterior portion of the vehicle, and when the illumination source is electrically operated to emit light, the vehicular illumination module projects the icon at a ground region at a side of the vehicle.

16. The method of claim 15, further comprising applying a second layer of spectrally-selective light absorbing material at the first side of the glass substrate, wherein the projected icon is at least partially colored by the second layer of spectrally-selective light absorbing material.

17. The method of claim 16, wherein forming the mask further comprises:
applying a second photoresistant layer onto the second layer of spectrally-selective light absorbing material and positioning a second mask template at the second photoresistant layer, wherein the second mask template comprises (i) a transmissive portion that at least partially allows UV light to pass through the mask template at the transmissive portion and (ii) a non-transmissive portion that at least partially blocks UV light from passing through the mask template at the non-transmissive portion; and
with the second mask template positioned at the second photoresistant layer, exposing the mask to UV light removes a first portion of the second photoresistant layer aligned with the transmissive portion of the second mask template and at least partially exposed to the UV light from the second layer of spectrally-selective light absorbing material, and wherein, with the second portion of the photoresistant layer removed from the second layer of spectrally-selective light absorbing material, a second portion of the second photoresistant layer aligned with the non-transmissive portion of the second mask template and at least partially blocked from exposure to the UV light remains at the second layer of spectrally-selective light absorbing material.

18. The method of claim 17, wherein forming the mask further comprises removing the first portion of the second layer of spectrally-selective light absorbing material from the first side of the glass substrate, and removing the second portion of the second photoresistant layer from the second portion of the second layer of spectrally-selective light absorbing material.

19. The method of claim 18, wherein the layer of spectrally-selective light absorbing material at least partially colors a first portion of the projected icon and the second layer of spectrally-selective light absorbing material at least partially colors a second portion of the projected icon.

20. The method of claim 18, wherein the layer of spectrally-selective light absorbing material and the second layer of spectrally-selective light absorbing material do not overlap at the first side of the glass substrate.

21. The method of claim 18, wherein the layer of spectrally-selective light absorbing material at least partially colors the projected icon a first color, and wherein the second layer of spectrally-selective light absorbing material at least partially colors the projected icon a second color, and wherein the second color is different from the first color.

22. The method of claim 18, wherein the exterior portion of the vehicle comprises one selected from the group consisting of (i) an exterior rearview mirror assembly of the vehicle and (ii) a door handle assembly of the vehicle.

23. A method of manufacturing a vehicular illumination module, the method comprising:
providing a housing;
disposing an illumination source at the housing, wherein the illumination source comprises a light emitting diode (LED);
forming a mask, wherein forming the mask comprises:
(a) providing a glass substrate, the glass substrate having a first side and a second side separated from the first side by a thickness dimension of the glass substrate;
(b) applying a layer of spectrally-selective light absorbing material at the first side of the glass substrate;
(c) with the layer of spectrally-selective light absorbing material applied at the first side of the glass substrate, applying a photoresistant layer onto the layer of spectrally-selective light absorbing material;
(d) with the photoresistant layer applied onto the layer of spectrally-selective light absorbing material, positioning a mask template at the photoresistant layer, wherein the mask template comprises (i) a transmissive portion that at least partially allows UV light to pass through the mask template at the transmissive portion and (ii) a non-transmissive portion that at least partially blocks UV light from passing through the mask template at the non-transmissive portion;
(e) with the mask template positioned at the photoresistant layer, exposing the mask to UV light, wherein exposing the mask to UV light removes a first portion of the photoresistant layer aligned with the transmissive portion of the mask template and at least partially exposed to the UV light from the layer of spectrally-selective light absorbing material, and wherein, with the first portion of the photoresistant layer removed from the layer of spectrally-selective light absorbing material, a second portion of the photoresistant layer aligned with the non-transmissive portion of the mask template and at least partially blocked from exposure to the UV light remains at the layer of spectrally-selective light absorbing material;
(f) wherein, after exposing the mask to UV light, a first portion of the layer of spectrally-selective light absorbing material is not covered by the photoresistant layer and a second portion of the layer of spectrally-selective light absorbing material is covered by the second portion of the photoresistant layer;
(g) removing the first portion of the layer of spectrally-selective light absorbing material from the first side of the glass substrate;
(h) removing the second portion of the photoresistant layer from the second portion of the layer of spectrally-selective light absorbing material; and
(i) wherein, with the first portion of the layer of spectrally-selective light absorbing material removed from the first side of the glass substrate and the second portion of the photoresistant layer removed from the second portion of the layer of spectrally-selective light absorbing material, the second portion of the layer of spectrally-selective light absorbing material remains at the first side of the glass substrate;
disposing the mask at the housing of the vehicular illumination module;
wherein, with the mask disposed at the housing of the vehicular illumination module, and when the illumination source of the vehicular illumination module is electrically operated to emit light, light emitted by the illumination source that passes through the mask forms an icon projected by the vehicular illumination module, and wherein the projected icon is at least partially colored by the second portion of the layer of spectrally-selective light absorbing material; and
wherein the vehicular illumination module is configured to be disposed at an interior portion of an interior cabin of a vehicle, and wherein, with the vehicular illumination module disposed at the interior portion of the interior cabin of the vehicle, and when the illumination source is electrically operated to emit light, the vehicular illumination module projects the icon at an interior surface within the interior cabin of the vehicle.

24. The method of claim 23, further comprising applying a second layer of spectrally-selective light absorbing material at the first side of the glass substrate, wherein the projected icon is at least partially colored by the second layer of spectrally-selective light absorbing material.

25. The method of claim 24, wherein forming the mask further comprises:
applying a second photoresistant layer onto the second layer of spectrally-selective light absorbing material and positioning a second mask template at the second photoresistant layer, wherein the second mask template comprises (i) a transmissive portion that at least partially allows UV light to pass through the mask template at the transmissive portion and (ii) a non-transmissive portion that at least partially blocks UV light from passing through the mask template at the non-transmissive portion; and
with the second mask template positioned at the second photoresistant layer, exposing the mask to UV light removes a first portion of the second photoresistant layer aligned with the transmissive portion of the second mask template and at least partially exposed to the UV light from the second layer of spectrally-selective light absorbing material, and wherein, with the second portion of the photoresistant layer removed from the second layer of spectrally-selective light absorbing material, a second portion of the second photoresistant layer aligned with the non-transmissive portion of the second mask template and at least partially blocked from exposure to the UV light remains at the second layer of spectrally-selective light absorbing material.

26. The method of claim 25, wherein forming the mask further comprises removing the first portion of the second layer of spectrally-selective light absorbing material from the first side of the glass substrate, and removing the second portion of the second photoresistant layer from the second portion of the second layer of spectrally-selective light absorbing material.

27. The method of claim 26, wherein the layer of spectrally-selective light absorbing material at least partially colors a first portion of the projected icon and the second layer of spectrally-selective light absorbing material at least partially colors a second portion of the projected icon.

28. The method of claim 26, wherein the layer of spectrally-selective light absorbing material and the second layer of spectrally-selective light absorbing material do not overlap at the first side of the glass substrate.

29. The method of claim 26, wherein the layer of spectrally-selective light absorbing material at least partially colors the projected icon a first color, and wherein the second layer of spectrally-selective light absorbing material at least partially colors the projected icon a second color, and wherein the second color is different from the first color.

30. The method of claim 23, wherein the interior portion of the vehicle comprises one selected from the group consisting of (i) an interior rearview mirror assembly of the vehicle and (ii) an overhead console of the vehicle.
